(19) United States
(12) Patent Application Publication
(10) Pub. No.: US 2016/0084527 A1
(43) Pub. Date: Mar. 24, 2016

(54) METHOD FOR CONTROLLING A HOT-BEVERAGE PREPARATION APPLIANCE HAVING CONTROLLED STEAM GENERATION

(71) Applicant: BSH HAUSGERÄTE GMBH, München (DE)

(72) Inventors: STEFAN BAUMGART, TROSTBERG (DE); JOSEF DABURGER, SIEGSDORF-HAMMER (DE); CHRISTIAN SCHNELLINGER, WONNEBERG (DE); FLORIAN SCHOLZ, TRAUNSTEIN (DE)

(21) Appl. No.: 14/785,403

(22) PCT Filed: Apr. 10, 2014
(86) PCT No.: PCT/EP2014/057274

§ 371 Date: Oct. 19, 2015

(30) Foreign Application Priority Data
Apr. 19, 2013 (DE) 10 2013 207 181.7

(51) Int. Cl. F24H 9/20; F24H 1/10; F24H 1/00; A47J 31/56

(52) U.S. Cl. CPC F24H 9/2028; A47J 31/56; F24H 1/101; F24H 1/0018

(57) ABSTRACT

A hot-beverage preparation device, in particular such a machine for household purposes, has a heater for water, a pump for conveying the water in the preparation device, a temperature sensor for detecting the temperature of the water downstream of the heater, and a control device for controlling the heater and the pump. A method for controlling the hot-beverage preparation device is developed by the following steps at the end of a brewing operation: a) detecting the temperature of the preparation water, b) heating the water, c) until steam is generated.

The invention relates to a method for controlling a hot beverage preparation appliance, in particular one for household purposes, having a heater for water, having a pump for conveying the water within the preparation appliance, having at least one temperature sensor for detecting at least the temperature of the water flow from the heater and having a control device for controlling the heater and the pump. The heater used for the preparation appliance can be for example a thermoblock, a flow-through water heater or a combination of the two. In expensive preparation appliances the pump can be replaced by a water connector to the household water network and is therefore not required. The control device controls the heater and the pump or in some instances from time to time just one of the two. To this end it can process in particular signals from the temperature sensor as well as user input.

It is known that preparation appliances, in particular those that process tea beverages and capsules, empty their systems and the beverage capsules by means of a steam jet. Such a device is set out in the application by the inventor with the reference number DE 10 2007 005 105 A1.

The steam jet is produced by stopping the pump after beverage preparation by means of the excess energy stored in the heater. The intensity of the steam jet can be changed by the time of deactivation of the heater. Once the strength of the steam jet has been set in the factory, it can however be changed by appliance tolerances or the degree of calcification of the heater.

The object of the invention is therefore to specify a system that allows the intensity of the steam jet to remain the same over the entire service life of the preparation appliance.

According to the invention this object is achieved for a method for controlling a hot beverage preparation appliance of the type mentioned in the introduction by the following steps at the end of a brewing operation:
a) detecting the temperature of the preparation water,
b) heating the water
c) until steam is generated.

The invention therefore moves away, regardless of the temperature conditions actually present, from using an as it were standardized energy outlay or largely identical fixed amount of energy to generate the steam jet. Rather it follows the principle, based on the temperature conditions actually present in the heater, in particular the temperature present in the heater after the end of a brewing operation after the temperature has been detected of introducing heat energy specifically until steam forms. According to the invention therefore a temperature profile is produced specifically, based on the temperature conditions actually present, in that the steam temperature is reached for example by means of a process loop. The process loop can consist of the repeated sequence of the steps of detecting the temperature of the preparation water and the subsequent heating of the water by a defined amount. Along with the temperature profile a pressure profile is generated, without reference to the previous flow through the heater or the residual energy stored therein. The inventive method is therefore independent so that disruptive influences, such as for example manufacturing tolerances or the degree of calcification of the heater do not influence the desired temperature and pressure profiles in a negative manner.

According to the invention therefore the detection of the temperature of the preparation water and the heating of the water can take place multiple times one after the other, until finally the desired temperature for steam formation is reached. According to one advantageous embodiment of the invention, after the temperature of the preparation water has been detected in step a) and before step b) in an intermediate step k), a temperature difference between the detected temperature and the desired steam temperature of the preparation water is determined. It is possible to use the detected temperature difference to calculate the amount of energy required to heat the preparation water until steam is formed. In step b) the water can then be brought specifically to steam temperature without having to go through a loop with intermediate steps for temperature detection. This accelerates the method sequence.

More expensive preparation appliances comprise not only a temperature sensor, specifically downstream of the heater, but also a second temperature sensor upstream of the heater. With such preparation appliances the abovementioned method can be varied in that in some instances even during the brewing operation in step a) both an input temperature of the water upstream of the heater and also its output temperature downstream of the heater are detected, these being used in a subsequent step r) to form a difference, which is then related in a further subsequent step s) to the heat energy invested for this purpose, with the heat energy required for the subsequent step b) for heating the water until steam is generated being determined therefrom. This method offers even greater accuracy, as it detects the required energy outlay as a function of the heating power actually present. It is therefore possible to neutralize both manufacturing tolerances during the production of the heater and therefore the difference between its power and that of other, comparable heaters, and any current degree of calcification that may be present. The method therefore achieves greater accuracy of steam generation which can be reflected on the one hand in an appropriate, perhaps shorter, in some instances even longer, method duration and on the other hand an appropriate energy outlay.

The method described last requires a certain technical outlay which can make the preparation appliance more expensive. According to a further advantageous embodiment of the invention therefore alternatively or additionally before the temperature is detected in step a) in a step o) the heater can be cooled in that the pump is switched off at a time after the heater. When the heater has been switched off and the flow through the heater has been maintained, the cool fresh water absorbs the residual energy remaining in the heater. A temperature drop therefore occurs, in particular in the case of a low-mass flow-through water heater. The pump is then also switched off so the then still water absorbs the remaining heat energy. This method, which is referred to as “early off”, has the advantage that it produces a largely defined, in any case stable pressure and temperature state below the steam temperature or below the steam pressure, which can be followed by a standard program for steps a) to c) for steam generation.

According to a further advantageous embodiment of the inventive method before step a) in a step n) the residual energy of the heater can be determined, in that the temperature progression and/or the flow of water and/or the heating power introduced into the water is detected. The temperature progression of the heater can be detected by constant or step by step measurement of the temperature. The flow of water through the heater can be detected by a flowmeter. Alternatively it can be calculated using a method according to the application DE 10 2011 079 542 B1 or DE 10 2013 201 180 by the applicant. It can be set as constant if a fixed water connector is used instead of a pump. Finally the heating power can be determined as an electrical variable at the input of the heater. If only one of these measurement values is known, the other variables can be calculated. When they are known the cooling power of the heater can be determined, so a loop like the one for heating the water until steam is generated is superfluous.

The method referred to as “early off” produces a certain energy loss with the temperature drop that occurs therein. According to a further advantageous embodiment of the invention therefore after step o) in a further step p) the heater and/or the pump can be regulated to a linear temperature profile of the water downstream of the heater in the direction of a defined target temperature value. Control of the heater and control of the pump are coordinate in such a manner that the temperature of the water downstream of the heater changes in a largely linear manner. Starting from a fixed time point for switching off the heater, the flow can be reduced for example to such a degree that a temperature drop can be avoided. When the flow then tends toward zero, the system is cooled. This method, referred to as “controlled early off”, is thus able to dissipate the residual energy specifically and establish a defined initial state for steam generation without uncontrolled steam production and without a major temperature drop.

According to a further advantageous embodiment of the invention the last-mentioned method is developed so that the defined target temperature value is the steam temperature of the water. After the end of the brewing operation therefore the heat and pump are regulated alone or together such that starting from the temperature level then present the water is brought to the steam temperature level specifically, in a controlled manner and without previous energy dissipation. The temperature and pressure levels can then be built up, maintained and reduced again in a controlled manner.

According to a further advantageous embodiment of the invention the method follows on from the brewing operation in such a manner that the user cannot perceive it as separate. Individual method steps can also be brought forward into the brewing operation, in particular in respect of detecting the temperature progression. Finally the flow through the heater and the control of the temperature of the water achieved therewith can be set so that the cited operations, in other words in particular steps b) and steps p) are still used as parts of the preparation operation or the flow is taken into account when measuring the quantity of beverage. The method therefore provides not only a high level of operational reliability in respect of the production of the steam jet but it also helps the preparation appliance consume little water and energy.

The principle of the invention is described in more detail in the following by way of example with reference to a drawing, in which:

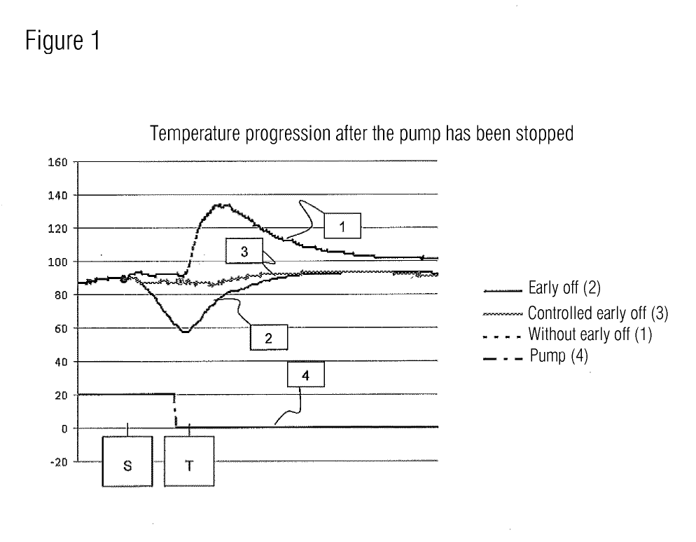

FIG. 1 shows three exemplary temperature profiles after the pump has been stopped,

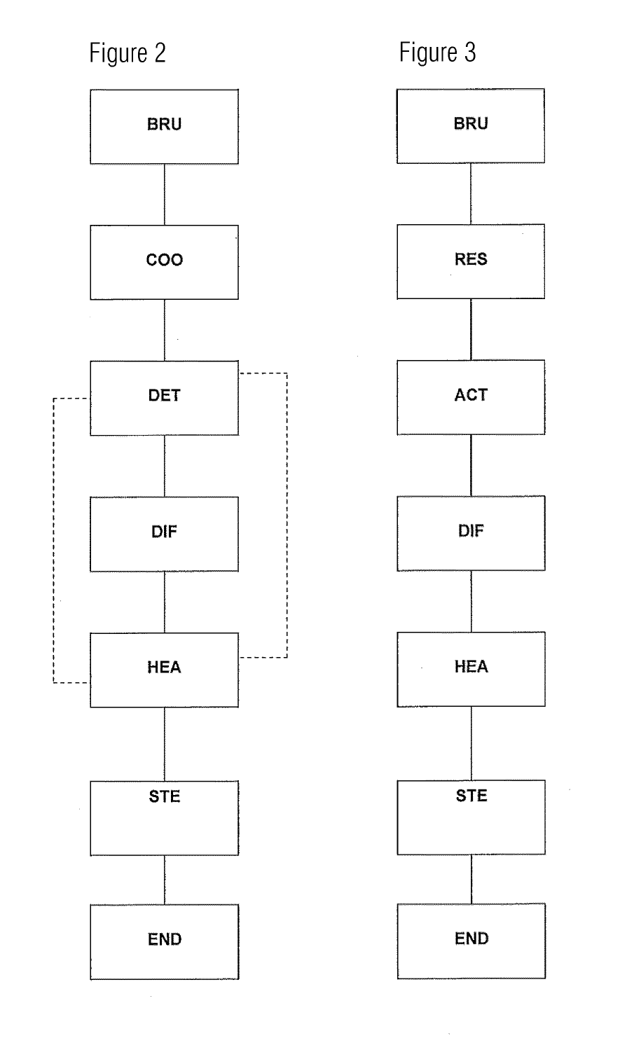

FIG. 2 shows a block diagram of a first method sequence,

FIG. 3 shows a block diagram of a second method sequence,

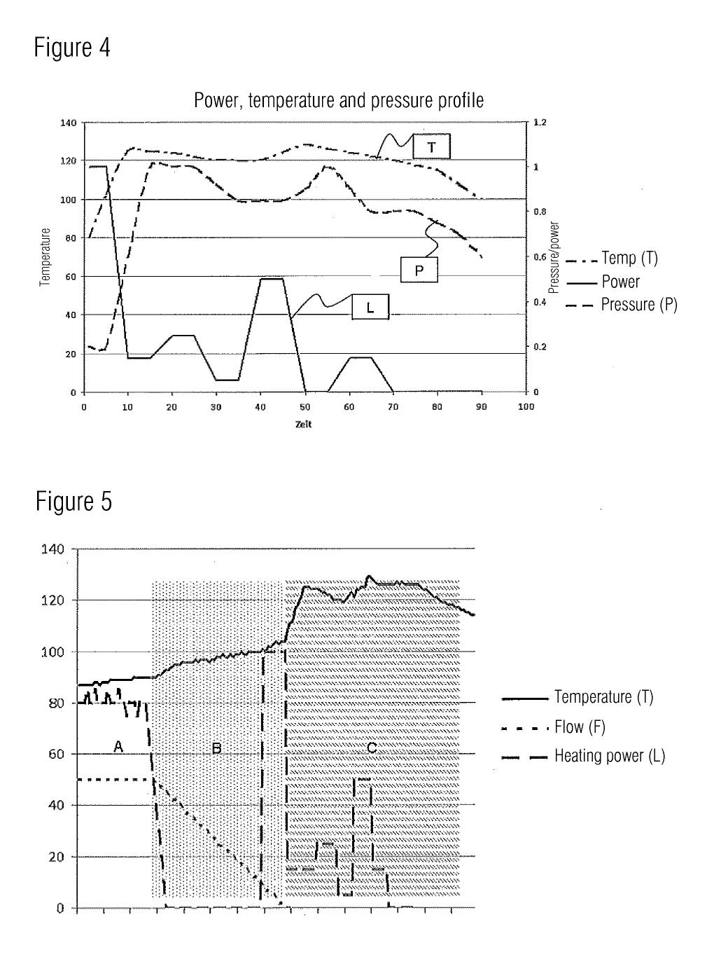

FIG. 4 shows an exemplary power, temperature and pressure profile, and

FIG. 5 shows an ideal profile for the three control variables.

FIG. 1 shows a diagram of a temperature progression (ordinate) over time (abscissa). All the temperature profiles (1), (2), (3) share the fact that the pump is switched off at a defined time point t. This is symbolized by the angled profile of the graph (4), according to which the pump is active before time point t, then inactive. With a first control method according to the prior art the heater was also switched off at the same time. This gives the temperature profile (1), in which because there is no water flowing in the heater, the now still water quickly heats up above the boiling point of water and generates a steam jet. A large part of the residual energy is thus emitted with the remaining energy escaping with subsequent evaporation, symbolized by the dropping profile of the curve (1) after the steam jet.

A second possibility according to the prior art is shown by the temperature profile (2). It is referred to as “early off” because in contrast to the first control method the heater is not switched off at time point t and therefore at the same time as the pump, but earlier, specifically at time point s. Unlike the first control method, in which heat energy is still supplied briefly to the heater after the pump has been switched off, the heater is switched off first, even before the flow of water through the heater is stopped. This means that without a supply of heat energy the temperature of the preparation water still being transported through the heater drops. It does this until approximately time point t, when the pump is also switched off. Because there is no fresh water being pushed through afterwards, the now still water heats up due to the residual heat of the heater, until there is temperature equilibrium from the residual energy of the heater and the water present therein, which has been heated up in the meantime. The temperature profile (2) therefore rises again after time point t, until it generally plateaus at approx. 90 degrees.

It is the purpose of the invention that an uncontrolled steam jet should not be generated, rather it should be brought about in a specific and controlled manner. To this end it is first of all necessary to establish a defined initial state in particular in respect of heater temperature. A specific temperature profile and with it a controlled or controllable steam profile are generated on this basis. According to the invention a method for generating a temperature profile according to (3) is performed for this purpose, being referred to as “controlled early off”. According to this the heater is also switched off at time point s and therefore before time point t. Unlike the previous methods however the pump is cut back in a regulated manner at time point s, specifically as a function of the temperature progression, and is only switched off completely at time point t. It is activated at least after the heater has been switched off taking into account the temperature profile, so that slight cooling of the preparation water first results. However the pump is then activated in such a manner that the flow is reduced until a largely constant water temperature is established downstream of the heater. Provided there is a largely stable temperature level, the flow then drops continuously until it comes to a halt. This time point can be detected using a flowmeter and signals the desired initial state by an equilibrium between the temperature of the water and the temperature of the heater. Specific activation for steam generation can take place on this basis. “Controlled early off” therefore avoids the temperature drop of the “early off” method and achieves the desired equilibrium or initial state at an earlier time point.

FIG. 2 shows a schematized flow diagram of individual method steps of the “early off” method. It starts with method step BRU, in which the brewing operation for preparing a hot beverage is completed. According to FIG. 1 this method step is before time point s. It is followed by a method step COO, in which the heater is cooled. To this end it is switched off, while the pump continues to run supplying more cool preparation water. This causes the temperature drop in the profile (2) according to FIG. 1, which lasts until shortly after the pump is switched off at time point t.

A certain time interval, around 2 to 5 seconds, then passes depending on the dead time of the system, until the temperature equalization between heater and water contained therein, as described in relation to FIG. 1, results. In a step DET the temperature present in this largely equilibrium state is measured to detect the initial state for steam generation.

In step DIF a temperature difference between the detected measurement value and the boiling temperature of the water is then determined. The amount of the temperature difference correlates with an amount of energy that has to be supplied to the heater to heat the water contained therein at least to boiling temperature. This takes place in a subsequent step HEA. The heating of the water is continued for a while, in order to generate steam and the associated pressure not just at a time point but over a certain time period, as shown by the method step STE. Both the steam generation method and also the brewing operation as a whole are therefore completed in step END.

As an alternative to step DIF in which a temperature difference between the measured temperature and the boiling temperature is determined, it is possible to run through the step DET for detecting the temperature present and the step HEA for heating the water a number of times in a loop shown with a broken line. Heating here takes place with a defined amount of energy which is always the same. In step DET the resulting new temperature is then detected. The loop consisting of the steps DET and HEA is continued until the boiling temperature is measured in step DET. The method is then continued with step STE as mentioned above.

FIG. 3 shows the “controlled early off” method in a similarly schematized manner. It starts with the method step BRU as described above and is followed by the method step RES, in which the residual energy of the heater is detected. To this end data obtained before the end of the brewing operation is evaluated, for example a temperature progression or the heating power applied in conjunction with the actual flow. With knowledge of the actual residual energy present after the end of the brewing operation it is possible to activate the pump and heater specifically in order to achieve a largely linear temperature profile, represented by the method step ACT. The largely linear temperature profile represents a stable initial state, from which steam generation is performed. The level of the largely unchanging or constant temperature profile is known or can be concluded from the previous detection of the residual energy. From this it is possible to determine a temperature difference in the abovementioned step DEF, said temperature difference having to be overcome to reach boiling temperature. The similarly known method steps HEA for heating the water to a step STE then follow, in that steam is produced for a time period. The method then ends in step END.

FIG. 4 shows an exemplary power, temperature and pressure profile with a time axis as the abscissa and a temperature or pressure and power axis as ordinates. It shows from the polygonal profile L for heating power that it takes place in segments standardized in respect of power and duration, known as energy blocks. The responses of the system to the change in heating power follow with a certain time delay, as can be identified from the temperature profile T and the pressure profile P. A certain system inertia means that despite the erratic profile L for heating power a largely smooth profile can be achieved from T and P for temperature and pressure.

FIG. 5 shows a relationship between the temperature profile T, the heating power L and a flow F during a “controlled early off” method. The graphic is divided into three regions A, B, C, of which the first (A) is not shown graphically, the second (B) is shown by a dotted area and the third (C) is shown by a lined area. The first region A characterizes the end of the brewing operation, for which a constant flow F, a heating power L at a relatively high level and a largely constant temperature T are present. Control of the pump and control of the heater are coordinated in such a manner that in the second region B, in which the heater is switched off, the flow F is already reduced to such a degree that the water does not cool but is even heated further, to boiling temperature. In this segment the saturated vapor pressure of the water is generated specifically, in that the liquid and vaporous phases of the water are in equilibrium. The equilibrium of both phases in a closed system is known to be a function of temperature. This fact is used to generate a steam/pressure profile. Shortly before the flow F comes to a halt, power is supplied to the heater. The increase in temperature causes so much water to evaporate and so much steam to escape that there is equilibrium of both phases again. In the third segment C a specific steam/pressure profile is generated simply by activating the heater, it being possible to keep the steam pressure and therefore the steam flow largely constant. This also optimally shortens the time period after the end of the actual brewing operation so that the emptying of the system by generating a steam flow does not appear to the user as a specific operation but as a regular conclusion of the brewing operation per se.

As the above methods described in detail are exemplary embodiments, they can be modified to a large degree in the usual manner by the person skilled in the art without departing from the scope of the invention. In particular the individual method steps of cooling the heater and detecting temperature during the equilibrium state can take place in a different manner from the one described here, in particular with the aid of a further temperature sensor. Also the use of the indefinite article “a” or “an” does not preclude the relevant features also being able to be present in greater numbers.

### LIST OF REFERENCE CHARACTERS

BRU: End of brewing operation
COO: Cooling of heater
DET: Detecting the temperature
DEF: Determining a temperature difference
HEA: Heating the water
STE: Steam generation
RES: Detecting the residual energy
ACT: Activating the heater and/or pump
END: End
s, t: Switching off times for pump and/or heater
T: Temperature profile
P: Pressure profile
L: Heating power profile
(1) Temperature progression according to prior art
(2) Temperature progression according to “early off” method
(3) Temperature progression according to “controlled early off” method

1-7. (canceled)

8. A method for controlling a hot beverage preparation device, the device having a heater for water, a pump for conveying the water in the preparation device, a temperature sensor for detecting a temperature of the water downstream of the heater in a conveying direction, and a control device for controlling the heater and the pump, the method comprising the following steps, to be performed at the end of a brewing operation:
a) detecting the temperature of the preparation water;
b) heating the water;
c) until steam is generated.

9. The method according to claim 8, which comprises performing the method steps in a hot beverage machine for household purposes.

10. The method according to claim 8, which comprises, subsequent to step a), performing a step k) of determining a temperature difference between the detected temperature and the steam temperature of the preparation water.

11. The method according to claim 8, wherein the hot beverage preparation device has a second temperature sensor upstream of the heater and the method further comprises:
in step a), detecting both an input temperature of the water upstream of the heater and also an output temperature of the water downstream of the heater;
forming a difference between the temperatures detected in step a) and relating the difference to a heat energy invested for heating the water, and determining therefrom the heat energy required for step b).

12. The method according to claim 8, which comprises, prior to detecting the temperature in step a), carrying out a step o) of cooling the heater by switching the pump off after a time delay following switching off the heater.

13. The method according to claim 8, which comprises, prior to step a), determining a residual energy by detecting a temperature progression and/or a flow of water and/or a heating power introduced into the water.

14. The method according to claim 12, which comprises following step o), effecting a closed-loop control of the heater and/or the pump to a linear temperature profile in a direction of a defined target temperature value.

15. The method according to claim 14, wherein the target temperature value is a steam temperature of the water.
